(19) United States
(12) Patent Application Publication
(10) Pub. No.: US 2004/0206116 A1
(43) Pub. Date: Oct. 21, 2004

(54) Method of preparation of glass articles

(75) Inventors: Koichiro Shiraishi, Fussa-shi (JP); Shigeaki Ohmi, Tokorozawa-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: HOYA CORPORATION, Tokyo (JP)

(21) Appl. No.: 10/658,466

(22) Filed: Sep. 10, 2003

(30) Foreign Application Priority Data
Sep. 11, 2002 (JP) 2002-264951

(51) Int. Cl. C03B 40/02

(52) U.S. Cl. 65/24

(57) ABSTRACT

A method of manufacturing a glass article comprises the steps of heat softening a glass material that has been preformed and press molding the glass material with a pressing mold. A glass material having a surface free energy of greater than or equal to 60 mJ/m² is fed to the heat softening step, and then fed to the press molding step. Alternatively, a surface layer is formed on a preformed glass material having a surface free energy of greater than or equal to 60 mJ/m², and then the preformed glass material is fed to the heat softening step and press molding step. Provided is a method of manufacturing glass products capable of easily obtaining glass products without surface fogging, clouding and cracking without large scale facility.

### TECHNICAL FIELD

The present invention relates to a method of manufacturing glass articles, in particular, optical glass elements, by press molding heat-softened glass materials in a pressing mold.

### TECHNICAL BACKGROUND

Mold pressing is known as a method of molding precision optical glass elements easily and with good productivity. The mold pressing is a method in which a glass material for molding that has been preformed a glass to a prescribed shape by melting and solidification or by cold processing is placed in a pressing mold and pressed while in a moldable state achieved by heat softening; and the molded glass element is then cooled while still in the mold to obtain a glass element. Since a precision processed mold is employed, the molded glass element obtained by this method does not require polishing.

When molding the glass elements by mold pressing, the glass material for molding and the mold come into close contact at temperatures exceeding the softening point of the glass. Thus, a reaction takes place at the interface of the glass and the mold, a portion of the glass fuses to the mold surface, fogging and clouding occur on the surface of the glass element, defects such as cracks are generated, and it is difficult to obtain good glass lenses.

Modifying the surface of the glass material in advance is a known method employed when faced with such problems.

Japanese Unexamined Patent Publication (KOKAI) Heisei No. 9-71424 (Patent Reference 1) discloses a method of exposing the glass material for molding at a reduced pressure of less than or equal to 10³ Pa at a temperature at which the viscosity of the glass material falls within a range of from 10⁹ to 10¹⁴ poises. In this method, fogging and clouding of the surface of the glass element are attributed to reactivity and volatization of the surface of the glass material for molded. To reduce these defects, a heat treatment is conducted under reduced pressure as set forth above.

A certain effect is achieved by this method. However, since heat processing under reduced pressure may render the outer surface of the glass material for molding nonuniform, when 500 or more molding cycles, for example, are continuously conducted with the same mold, partial fusion to the surface of the mold or the surface of the mold separation film provided on the mold occurs, increasing the failure rate and precluding the obtaining of satisfactory results.

Further, forming a film on the surface of the glass material is another known method.

Japanese Examined Patent Publication (KOKOKU) Heisei No. 2-31012 (Patent Reference 2) describes a method of preventing fusion by forming a carbon film on at least either the surface of the glass or the opposing surface of the mold.

Japanese Unexamined Patent Publication (KOKAI) Heisei No. 8-277125 (Patent Reference 3) describes a method of forming a coating of a group IIIA metal oxide such as yttrium oxide or cerium oxide by vacuum deposition or sputtering on the surface of the glass.

Japanese Unexamined Patent Publication (KOKAI) Heisei No. 11-236225 (Patent Reference 4) describes a method of forming a coating of a sulfide or selenide of Mo, W, Nb, or the like on the glass surface by vacuum deposition or sputtering.

Although certain effects are achieved by the methods described in the above-cited patent references, they are unsatisfactory in that clouding, fogging, and cracking occur either gradually or suddenly on the surface of the optical glass element following molding when, for example, 1,000 or more cycles of continuous molding are conducted continuously with a single mold.

The present invention, devised in light of the above-described situation, has for its object to provide a method of manufacturing glass articles in which fusion during press molding, and the resultant clouding, fogging, and cracking, are prevented.

### DISCLOSURE OF THE INVENTION

The present invention, which solves the above-described problems, relates to a method of manufacturing glass articles comprising the steps of heat softening a glass material that has been preformed and press molding the glass material with a pressing mold, characterized in that a glass material having a surface free energy of greater than or equal to 60 mJ/m² is fed to the heat softening step, and then fed to the press molding step.

In the present invention, the preformed glass material is desirably washed to achieve a surface free energy of greater than or equal to 60 mJ/m², and kept in an atmosphere capable of maintaining a surface free energy of greater than or equal to 60 mJ/m² until the start of the heat softening step.

The present invention further relates to a method of manufacturing glass articles comprising the steps of heat softening a glass material that has been preformed and press molding the glass material with a pressing mold, characterized in that a surface layer is formed on a preformed glass material having a surface free energy of greater than or equal to 60 mJ/m², and then the preformed glass material is fed to the heat softening step and press molding step.

In the above invention, it is desirable that (1) the surface layer is a thin film comprised primarily of carbon with a film thickness of greater than or equal to 0.1 nm and less than or equal to 1 micrometer, and that (2) the preformed glass material is washed to achieve a surface free energy of greater than or equal to 60 mJ/m² and kept in an atmosphere capable of maintaining a surface free energy of greater than or equal to 60 mJ/m² until the surface layer is formed.

### BRIEF DESCRIPTION OF THE FIGURES

FIG. 1 is a descriptive drawing of a glass material for molding.

FIG. 2 is a descriptive drawing of the glass material for molding having a surface layer.

FIG. 3 is a descriptive drawing of self-assembled film.

FIG. 4 is the IR-RAS spectrum of a self-assembled film.

FIG. 5 is a descriptive drawing of a self-assembled film comprised of multiple molecular layers.

### BEST MODE FOR IMPLEMENTING THE INVENTION

The present invention is a method of manufacturing glass articles comprising the steps of heat softening a glass material that has been preformed and press molding it with a pressing mold. The first mode is characterized in that a glass material having a surface free energy of greater than or equal to 60 mJ/m² is fed to the heat softening step, and then fed to the press molding step. The second mode is characterized in that a surface layer is formed on a glass material having a surface free energy of greater than or equal to 60 mJ/m², and then the preformed glass material is fed to the heat softening step and press molding step. In both of these modes, a glass material having a surface free energy of greater than or equal to 60 mJ/m² is employed as the preformed glass material.

Experience has revealed that such defects in appearance as clouding and cracking of a molded optical element result primarily from fusion of the glass material employed in molding to the surface of the mold or to the surface of a mold separation film provided on the surface of the mold. The present inventors conducted a precision investigation, discovering that most fusion is the result of foreign matter adhering to the surface of the mold or to the surface of the mold separating film. Surface analysis by ESCA and the like identified the major components of such foreign matter as being organic matter not contained in the glass material employed in molding. Further investigation revealed that contamination present on the surface of the glass material employed in molding was generated suddenly during pressing, or trace amounts of contaminants gradually concentrated on the surface of the mold or the surface of the mold separation film with repeated pressing.

Further, when a carbon film was formed on the surface of the glass material employed in molding, although the number of pressing cycles at which fusion defects increased sharply was extended, fusion defects still increased sharply when continuous pressing was conducted about 1,000 times. Accordingly, an examination of a mold surface on which fusion defects had increased sharply revealed that foreign matter had adhered in the same manner as set forth above. Surface analysis by ESCA and the like similarly revealed that the main component of the foreign matter was organic matter not contained in the glass material employed in molding. Even when a carbon film was formed on the surface of the glass material employed in molding, the trace amount of contamination on the surface of the glass material employed in molding was found to concentrate on the surface of the mold or on the surface of the mold separating film with repeated pressing.

Since the amount of organic contaminants present on the surface of the glass material employed in molding is quite small, direct evaluation thereof is difficult. However, the present inventors discovered that the organic contamination on the surface of the glass material employed in molding could be quantitatively evaluated by the Owens-Wendt-Kaelble method based on wetting angle measurement with pure water, CH₂I₂, glycerin, isopentane, perfluorooxane, and the like. Glass materials employed in molding with low surface free energy levels were determined to have high degrees of organic contamination. The changes in the surface energy of glass materials employed in molding and the fusion defect rate based on the number of pressing cycles was investigated.

The surface free energy can be measured with a known contact angle measuring device. That is, two of the liquids listed above are employed to measure the wetting angle (contact angle) of the surface being measured and the surface free energy is calculated. For example, the surface free energy can be evaluated by the Owens-Wendt-Kaelble method based on measurement of the wetting angles of pure water and CH₂I₂ in the following manner. The surface free energy (γ) is given by the sum of the dispersion force γd and the polar interaction force γp of the liquids.

γ=γ^{d}+γ^{p} (1)

Considering Equation (1) as the surface free energy of a solid gives:

γₛ=γₛ^{d}+γₛ^{p} (2)

Here, subscript s denotes “Solid”.

Similarly, for a liquid:

γ_{L}=γ_{L}^{d}+γ_{L}^{p} (3)

Subscript L denotes “Liquid”. The surface free energy of a film is calculated from the contact angles obtained by dripping equal quantities of the two liquids water and CH₂I₂ (diiodomethane) on a solid.

The following computation equation was employed based on the Owens-Wendt-Kaelble method:

$$\frac{1}{2} \times {γ}_{L} \times ( 1 + cos θ ) = {( {γ}_{s}^{d} \times {γ}_{L}^{d} )}^{\frac{1}{2}} + {( {γ}_{s}^{p} \times {γ}_{L}^{p} )}^{\frac{1}{2}} \qquad ( 4 )$$

Employing γ_{L}^{d} and γ_{L}^{p} values from the literature for the two liquids shown in Table 1, the γ_{L} value of each of the two liquids was calculated from Equation (3).

TABLE 1
The energy values of individual liquids (values from the literature)

| | γ _{L}^{d} | γ _{L}^{p} | γ _{L} |
|---|---|---|---|
| Water | 21.8 | 51 | 72.8 |
| Diiodomethane | 50.8 | 0 | 50.8 |

For example, a water contact angle of 104.9° and a diiodomethane contact angle of 72.0° were substituted for θ of Equation (4) and the energy values of Table 1 were employed for the other values. This gave:

$$\begin{matrix}\begin{matrix}\frac{1}{2} \times 72.8 \times ( 1 + cos 104.9 ) = {( {γ}_{s}^{d} \times 21.8 )}^{\frac{1}{2}} + {( {γ}_{s}^{p} \times 51.0 )}^{\frac{1}{2}} \\ 27.04 = 4.67 \times {( {γ}_{s}^{d} )}^{\frac{1}{2}} + 7.14 \times {( {γ}_{s}^{p} )}^{\frac{1}{2}}\end{matrix} & ( 5 ) \\ \begin{matrix}\frac{1}{2} \times 50.8 \times ( 1 + cos 72.0 ) = {( {γ}_{s}^{d} \times 50.8 )}^{\frac{1}{2}} + {( {γ}_{s}^{p} \times 0 )}^{\frac{1}{2}} \\ 33.25 = 7.13 \times {( {γ}_{s}^{d} )}^{\frac{1}{2}} + 0 \\ ∴ {γ}_{s}^{d} = 21.67\end{matrix} & ( 6 )\end{matrix}$$

Substituting γs^{d} obtained from Equation (6) into Equation (5) gave:

$$\begin{matrix}27.04 = 4.67 \times {( 21.76 )}^{\frac{1}{2}} + 7.14 \times {( {γ}_{s}^{p} )}^{\frac{1}{2}} \\ ∴ {γ}_{s}^{d} = 0.59\end{matrix} \qquad ( 7 )$$

Substituting the values of Equations (6) and (7) into Equation (2) gave:

γₛ=21.76+0.59=22.30

Thus, a solid surface free energy γs of 22.30 mJ/m² was obtained.

Table 2 shows the results of the investigation of the change in surface free energy fusion defect rate based on the number of pressing cycles for the glass material employed in molding made of glass A comprised of borate optical glass. From these results it will be understood that at a surface free energy equal to or greater than 60 mJ/m² in the glass material employed in molding, the occurrence of fusion increased remarkably. The same investigation was conducted for the case where a carbon film was formed on the surface of the glass material employed in molding. The results are given in Table 3. In that case, as well, the formation of a surface layer on a glass material employed in molding with a surface free energy equal to or greater than 60 mJ/m² was found to result in remarkable reduction of the occurrence of fusion.

TABLE 2
Change in the fusion defect rate with continuous pressing of a glass
material employed in molding in the form of borate glass (glass A)

| | | | | 2000 |
|---|---|---|---|---|
| Surface free | 500 Pressing | 1000 Pressing | 1500 Pressing | Pressing |
| energy | cycles | cycles | cycles | cycles |
| <55 mJ/m² | 8% | 89% | — | — |
| 55 to 59 mJ/m² | 0% | 0% | 8% | 71% |
| 60 to 64 mJ/m² | 0% | 0% | 0% | 15% |
| ≧65 mJ/m² | 0% | 0% | 0% | 2% |

TABLE 3
The change in the fusion defect rate with continuous pressing
of a glass material employed in molding made of glass A on
the surface of which has been formed a carbon film

| | | | 2000 | 3000 |
|---|---|---|---|---|
| Surface free | 1000 Pressing | 1500 Pressing | Pressing | Pressing |
| energy | cycles | cycles | cycles | cycles |
| <55 mJ/m² | 49% | 96% | — | — |
| 55 to 59 mJ/m² | 0% | 2% | 31% | — |
| 60 to 64 mJ/m² | 0% | 0% | 0% | 9% |
| ≧65 mJ/m² | 0% | 0% | 0% | 4% |

The present invention was devised on the basis of these discoveries. The use of a glass material employed in molding with a surface free energy of greater than or equal to 60 mJ/m² remarkably reduces fusion defects.

When a glass material with a surface energy of less than 60 mJ/m² is continuously employed in press molding, contamination tends to adhere to and concentrate on the surface of the mold or on the surface of the mold separation film provided on the surface of the mold after only a low number of pressing cycles. As a result, the contamination (organic matter) causes a reaction at the interface, resulting in adhesion of the glass material to the surface of the mold or to the surface of the mold separation film. In particular, a large amount of sub-micrometer fusion takes place. Thus, optically mirror-finished mold surfaces or mold-separation film surfaces are roughened and irregularities are generated. The transfer of these irregularities causes defects such as fogging and clouding of the molded optical element. Further, cracking of the optical element takes place at the site of fusion as the starting point. The above tables thus reveal that the use of a glass material with a surface free energy of greater than or equal to 65 mJ/m² is desirable.

A glass material employed in molding with a surface free energy of greater than or equal to 60 mJ/m² can be obtained by precision cleansing. Further, minute organic contamination adheres to and is adsorbed onto the surface of the glass material employed in molding from the atmosphere, and organic contamination increases over time. As this occurs, the surface free energy decreases over time after cleansing. Accordingly, during the period between cleansing and pressing, it is important to store the glass material employed in molding in a clean environment.

Methods of precision cleansing the glass material employed in molding that are suitable for use include a wet method based on the physical separation of contamination, lift-off of contamination accompanying substrate surface etching, and the dissolution of contamination; and dry methods employing oxidation decomposition of contaminants typified by UV ozone treatment and oxygen plasma treatment.

Normally, the wet method can be conducted in the order of “physical separation”, “lift-off of contamination accompanying substrate surface etching”, and “dissolution of contamination”.

In “physical separation”, a method such as ultrasound or brushing is employed. A chemical solution such as a cleaning agent (acidic, neutral, or alkaline) can be added to enhance the cleansing effect, and the synergistic effect of physical and chemical actions can be used to more efficiently remove contamination. For example, a process such as the following can be employed:

Ultrasound or brushing; the ultrasonic waves ranging from several KHz to several MHz and the brushing being optical brushing.

Chemical solution such as a cleansing agent (acidic, neutral, alkaline); a general optical cleansing agent solution (anionic surfactant, nonionic surfactant, or the like).

Cleansing duration and temperature: 0.5 to 15 min; 20-70° C. Rinsing after cleansing. Pure water is generally employed for rinsing.

In “lift-off of contamination accompanying substrate surface etching”, the glass material employed in molding is immersed in a solution to which has been added an acidic or alkaline chemical agent suited to etching the surface of the glass material employed in molding. To enhance the effect, ultrasound, heat, or the like may also be employed. Examples of acidic and alkaline chemical agents are solvents to which chemical agents such as ammonium hydrogencarbonate, ammonium hydrogenfluoride, ammonium carbonate, and ammonium hydroxide have been added. Pure water cleaning duration and temperature: 0.5 to 60 min, 20-70° C. Rinsing is conducted after cleansing. Generally, pure water is employed in rinsing.

In the “dissolution of contamination”, particularly in the dissolution of organic contaminants, the glass material employed in molding is immersed in an organic solvent such as ethyl ether, acetone, or isopropyl alcohol. To enhance the effect, ultrasound, heating or the like may be employed. Cleansing duration and temperature: 0.5 to 15 min, 20 to 70° C. Isopropyl alcohol is generally employed for rinsing. Following rinsing, vapor drying is often employed.

The glass material employed in molding that has been precision cleansed to impart a surface free energy of greater than or equal to 60 mJ/m² is desirably kept isolated from sources of organic contamination that could decrease the surface free energy. Methods of storing the glass material employed in molding include clean environments from which sources of organic contamination have been eliminated; for example, an environment corresponding to a total organic carbon concentration in the air of less than or equal to 1,000 micrograms C/L is desirable, less than or equal to 500 micrograms C/L is preferred, and less than or equal to 100 micrograms C/L is of even greater preference. The total organic carbon concentration referred to here is a value obtained by measuring the total organic carbon concentration with a known TOC (total organic carbon) measurement device in an aqueous sample where air is bubbled through pure water at a flow rate of 1 L/min, and converting the measured value to a value corresponding to the total organic carbon concentration in one liter of air.

Specifically, assuming a total quantity of bubbled air of 20 L and a TOC in the aqueous sample of 100 micrograms/L, the total organic carbon concentration in the air is 100 micrograms C per liter/20 L=100 micrograms C per liter. To achieve a total organic carbon concentration of less than or equal to 1,000 micrograms C/L, it is desirable to isolate the glass material employed in molding so that organic compounds such as alcohols are not present during the storage of the glass material and are not present in the transport environment.

Further, it is appropriate to control the degree of cleanliness of the environment of the glass material employed in molding. For example, a clean room or clean booth corresponding to ISO class 5 or smaller is desirable, class 4 is preferred, and class 3 or smaller is of even greater preference. The classes referred to here are based on ISO-14644 (Part 1). An ISO class is the power of 10 of the number of particles of greater than or equal to 0.1 micrometer in diameter present in one cubic meter and, it is denoted as class X when the number is 10^{x} particles/m³.

The degree of cleanliness can be measured with a known particle counter (optical scattering coefficient device) based on the method of ISO-14644.

In dry cleansing, known oxygen plasma cleansers, hydrogen plasma cleansers, and UV ozone cleansers can be employed. Argon ion etching may also be employed.

As set forth above, organic matter present in the atmosphere adheres to the surface of the glass material employed in molding and causes a decrease in surface free energy. Accordingly, to reliably feed glass material employed in moldings having a surface free energy of greater than equal to 60 mJ/m² during press molding, before heat softening the glass material employed in molding, each lot of glass material employed in molding is desirably subjected to a surface free energy sampling inspection. Only lots with minimum surface free energy levels of greater than or equal to 60 mJ/m² based on the results of the inspection are then employed in the heat softening step. The glass material employed in moldings of lots with a minimum surface free energy of less than 60 mJ/m² are then subjected anew to precision cleansing. The storage and transport environments are desirably cleaned so that the variation in surface free energy of the multiple glass materials within a lot have a median value of ±5 mJ/m², preferably ±2 mJ/m².

Neither the composition nor shape of the glass material employed in the present invention is specifically limited. However, the present invention is particularly effective in glass materials tending to fuse, such as glass materials of optical glasses such as fluorophosphate, phosphate, borate, and borophosphate having high reactivity with the molding surface (or mold separation film on the molding surface).

Further, a surface layer can be formed on a preformed glass material employed in molding having a surface free energy of greater than or equal to 60 mJ/m² with the goal of enhancing mold separation for lens shapes such as concave meniscus and biconcave shapes that tend not to separate readily from the mold, for the above-listed compositions having high reactivity with the molding surface (or mold separation film on the molding surface), and for glass materials with high pressing temperatures (for example, with a Tg of greater than or equal to 550° C.) that tend to wear down the molding surface or separation film of the mold. Preferably, a surface layer is formed on glass materials with a surface free energy of greater than or equal to 65 mJ/m².

Molding-use glass materials with a surface free energy of greater than or equal to 60 mJ/m² are precision cleansed as set forth above and stored in a clean environment with few organic compound contaminants. Prior to forming a surface layer on the glass material employed in molding, each lot of glass material employed in molding is subjected to a surface free energy sampling inspection. Only the glass material employed in moldings of lots having a minimum surface free energy of greater than or equal to 60 mJ/m² are fed to the surface layer forming step. The forming-use glass material of lots having a minimum surface free energy of less than 60 mJ/m² are subjected anew to precision cleansing. In the same manner as above, the surface layer is desirably formed when the variation in surface free energy within a lot has a median value of less than or equal to ±5 mJ/m², preferably less than or equal to ±2 mJ/m².

The surface layer will be described further below. However, during the formation of the surface layer, the surface free energy decreases relative to the level prior to surface layer formation. Forming a surface layer is advantageous in that, since the contamination rate of the glass material decreases greatly relative to glass materials that have not been provided with a surface layer, a certain effect is achieved (an effect of preventing defects such as fogging and clouding in the optical elements that have been molded) even without storage control in a clean environment such as set forth above.

Examples of surface layers provided on glass materials are thin films comprised primarily of carbon and self-assembled films. Thin films comprised primarily of carbon may be selected from among diamond, diamond-like carbon films (DLC films hereinafter), hydrogenated diamond-like carbon films (DLC:H hereinafter), tetrahedral amorphous carbon films (ta-C hereinafter), hydrogenated tetrahedral amorphous carbon films (ta-C:H hereinafter), amorphous carbon films (a-C hereinafter), and hydrogenated amorphous carbon films (a-C:H hereinafter).

Further, thin films comprised primarily of carbon can be formed by CVD, DC-plasma CVD, RF-plasma CVD, microwave plasma CVD, ECR-plasma CVD, optical CVD, laser CVD, and other plasma CVD methods; ion plating and other ionization vapor deposition methods; sputtering; vapor deposition; and the filtered cathodic arc (FCA) method. The thickness of the thin film comprised primarily of carbon is desirably about from 0.1 nm to 1 micrometer, with from 0.5 nm to 100 nm being particularly suitable. An excessively thin film tends to result in decreased mold separation. An excessively thick film tends to cause saturation of preventive effects on fusion, clouding, fogging, and/or cracking, and the surface layer of the glass material employed in molding tends to become nonuniform; variation also tends to increase.

Self-assembled films are known in the literature; for example, see Hiroyuki SUGIMURA, Osamu TAKAI: Research Materials of the 199^{th} Meeting of the 131^{st} Committee on Thin Films of the Japan Society for the Promotion of Science, Feb. 1, 2000, pp. 34-39; and Seunghwan Lee, Young-Seok Shon, Ramon Colorado, Jr., Rebecca L. Guenard, T Randall Lee, and Scott S. Perry: Langmuir Vol. 16 (2000), pp. 2220-2224. As shown in FIG. 3, the coverage rate of film 7 formed by molecules 5 in solution 4 as they self-align and assemble themselves on the surface of coating film base material 6 is nearly 100 percent. Self-assembled films can be formed by immersing a glass material, for example, in a coating solution for self-assembled film.

In the glass material on which a self-assembled film has been provided, an organic molecule association product in which the molecules are aligned is formed on the outermost surface thereof, permitting significant reduction in friction with objects that come into contact with it.

For example, an organic single-molecule film in which the organic molecules are aligned can be formed by selecting a specific organic molecule; exposing the glass material to a solution containing the organic molecule at prescribed concentration in a nonpolar organic solvent, for example; and adjusting the reaction conditions. Since the organic molecules form a film by reacting with groups on the surface of the coating film base material and aligning themselves, a film with an extremely high coverage rate can be achieved. For efficient film formation, it is possible to preprocess the glass surface. Examples of organic molecules are reactive organic silicon-containing compounds, reactive organic sulfur-containing compounds, reactive organic fluorine-containing compounds, and reactive organic nitrogen-containing compounds. Examples of the functional groups in the organic compounds that are capable of automatically and spontaneously reacting with the surface of the film-coated base material (glass) are primarily —Cl groups in organic silicon-containing compounds (reaction Equation (1) below), primarily —H and (S—S) groups in organic sulfur-containing compounds (reaction Equations (2) and (3) below), and primarily —H groups in organic nitrogen-containing compounds (reaction Equation (4) below). Examples of compounds that may be employed in the reaction between the functional group (O portion) of molecule 4 of solution 3 and the surface of film-coated base material 5 are given below.

When there is a group with a chlorine atom in the organic compound, such as chlorotrialkyl silane compounds, dichlorodialkyl silane compounds, and trichloroalkyl silane compounds, it serves as the reactive functional group. As shown in Reaction Equation (1), it reacts automatically and spontaneously with the —OH group of the surface of film-coated base material (glass) 5, forming a self-assembled film with the above-described compound as the starting material on the surface of film-coated base material 5.

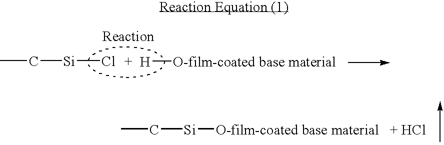

The above reaction progresses because a clean glass surface is highly reactive and reacts with water molecules in the air when exposed to a clean atmosphere, covering the entire surface of the glass with —OH groups.

Further, in the case of alkanethiol compounds, for example, the H atom bonding to the S atom in the thiol group of the compound becomes the functional group, and as is shown in Reaction Equation (2), reacts automatically and spontaneously with the —OH group on the surface of film-coated base material 3, forming a self-assembled film on the surface of film-coated base material 3 with the above-described compound as starting material.

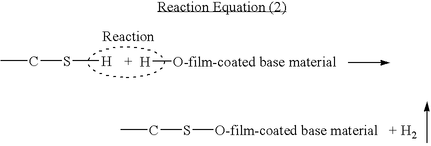

Further, in the case of dialkyldisulfide compounds, for example, the S—S bond in the compound serves as the functional group, and as is shown in Reaction Equation (3), reacts automatically and spontaneously with the —OH group on the surface of film-coated base material 3, forming a self-assembled film on the surface of film-coated base material 3 with the above-described compound as starting material.

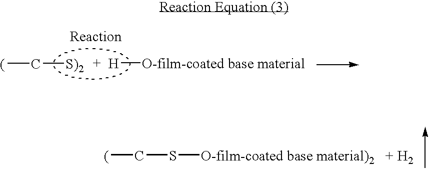

In the case of dimethylammonium compounds and alkyldimethyl (dimethyl-amino) silane compounds, the H atom bonded to the N atom in the compound serves as the functional group, and as shown in Reaction Equation (4), reacts automatically and spontaneously with the —Cl group on the surface of film-coated base material 3, forming a self-assembled film on the surface of film-coated base material 3 with the above-described compound as starting material.

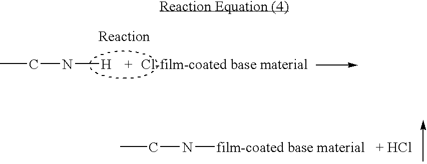

During film formation above, the glass surface is exposed to a clean, dry atmosphere containing chlorine and the reaction progresses with the surface covered with —Cl groups.

As set forth above, it is necessary for a compound having a functional group automatically or spontaneously reacting with the —OH group or —Cl group of the surface of the film-coated base material to be brought into contact with the surface of the film-coated base material in a state in which the reactivity of the functional group is preserved to form a self-assembled film. For example, when an organic compound comprising a self-assembled film as starting material is placed in an atmosphere comprising equivalent quantities of water and chlorine, the reactivity of the functional group tends to be lost. Accordingly, the organic compound is desirably stored in a state in which the reactivity of the functional group is maintained.

In the reaction to form a self-assembled film, it is preferred that the reaction rate is quite high. As stated for Reaction Equations (1) to (4), —Cl groups, —H groups, and (S—S) groups are desirable because of their high reaction rates. Further, when a starting material having a functional group with a low reaction rate such as an OR group (alkoxy group) is employed, the reaction shown in Reaction Equation (5) below takes place. However, this reaction progresses slowly and the film formation rate is correspondingly low.

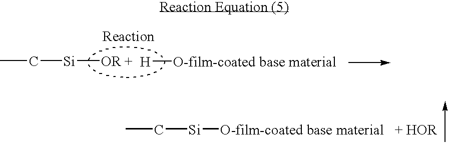

Further, although the organic compound molecule employed as the starting material of the self-assembled film in the present invention has the above-described functional group at a terminal position, it may have an alkyl group, aryl group, vinyl group, epoxy group, or fluorine on the other terminal (the surface terminal side when the above-described functional group serves as the bonding terminal). An alkyl group or aryl group is preferred. When such a group is present, it is possible to conduct good press molding in which fusion, cracking, and fogging are prevented.

The following are examples of compounds that may be employed as the reactive organic silicon-containing compounds, organic sulfur-containing compounds, organic fluorine-containing compounds, and organic nitrogen-containing compounds employed as the starting materials of the self-assembled film. However, such compounds are not limited to this list; any compound capable of forming a self-assembled film on the glass material may be employed.

Examples of chlorotrialkyl silane compounds are: chlorotrimethyl silane, chlorotriethyl silane, pentafluorophenyl dimethylchlorosilane, tert-butyldimethyl chlorosilane, (3-cyanopropyl)dimethyl chlorosilane, chlorotrifluoromethyl silane, and derivatives thereof. Examples of dichlorodialkyl silane compounds are dichlorodimethyl silane, dichloromethylvinyl silane, dichlorodifluoromethyl silane, dichloro-n-octadecylmethyl silane, n-octylmethyl dichlorosilane, dichlorocyclohexylmethyl silane, and derivatives thereof. Examples of trichloroalkyl silane compounds are trichlorovinyl silane, n-octadecyl trichlorosilane, isobutyl trichlorosilane, n-octafluorodecyl trichlorosilane, cyanohexyl trichlorosilane, and derivatives thereof. An example of a trichloroaryl silane compound is phenyl trichlorosilane. Examples of alkyldimethyl-(dimethylamido) silane compounds are trimethyl(dimethylamide) silane, triethyl(dimethylamido) silane, pentafluorophenyldimethyl(dimethylamido) silane, trifluoromethyl(dimethylamido)silane, tert-butyldimethyl(dimethylamido)silane, (3-cyanopropyl)dimethyl(dimethylamido)silane, and derivatives thereof. Examples of alkanethiol compounds are 1-butanethiol, 1-decanethiol, 1-fluorodecanethiol, o-aminothiophenol, 2-methyl-2-propanethiol, n-octadecanethiol, and derivatives thereof. Examples of dialkylsulfide compounds are ethyl methyl sulfide, dipropyl sulfide, n-hexyl sulfide, fluoroethylmethyl sulfide, phenylvinyl sulfide, derivatives thereof, ethyl phenyl sulfides, and derivatives thereof. Examples of dialkyldisulfide compounds are p-tolyldisulfide, diallyldisulfide, methylpropyldisulfide, fluoromethylpropyldisulfide, difurfuryldisulfide, derivatives thereof, methylphenyldisulfide, and derivatives thereof. Examples of dimethylammonium compounds are dihexadecyldimethylammonium acetate, dioctadecyldimethylammonium acetate, dieicosyldimethylammonium bromide, dimethyldioctadecylammonium iodide, dioctafluorodecyldimethylammonium acetate, dimethyldioleylammonium iodide, and derivatives thereof.

The self-assembled film of the present invention can be formed by immersing preformed glass in an organic solution (referred to hereinafter as a “coating solution”) in which the above-described organic molecules serving as starting materials for the self-assembled film have been dissolved. The solvent employed in the organic solution is desirably an anhydrous organic solvent. This is to avoid causing the organic compound molecules in the starting materials to lose their reactivity due to reaction with water molecules. When a solvent having polarity is employed, bonds are also similarly formed with the organic compound molecules, causing the organic compound molecules to lose their reactivity. Thus, a nonpolar solvent is desirably selected. That is, the solvent employed is desirably selected from among solvents maintaining the reactivity of the functional groups of the organic compound molecules.

Specific examples of preferred solvents are anhydrous nonpolar organic solvents such as hexane; anhydrous organic solutions of toluene and chloroform; and mixtures of these solvents.

When diluting the starting compounds of the self-assembled film with organic solvents having polarity such as alcohols, the functional group sometimes reacts with the —OH group in the alcohol, as shown in Reaction Equation (6) below, causing the functional group to be lost and causing the —OH group of the surface of the film-coated base material to tend not to react with a —Cl group. Thus, the organic solvent desirably does not contain an —OH group.

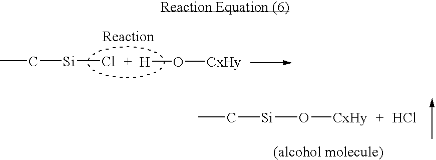

The concentration of the starting materials in the above coating solution desirably falls within the range of from 0.01 to 10 weight percent, preferably within the range of 0.1 to 5 weight percent. An excessively low concentration results in an inadequate coating rate, and an excessively high concentration does not raise the coating rate, conversely tending to decrease it. For example, the glass is immersed for about one minute in a coating solution prepared by diluting the starting materials of the self-assembled film with an anhydrous organic solvent such as benzene, toluene, xylene, or hexane. The glass is then removed from the coating solution, cleansed, dried at a temperature of from room temperature to 100° C. for about 30 minutes.

In addition to the immersion method, a self-assembled film can be obtained by exposing a preformed piece of glass to a vapor, mist, gas, or the like containing the starting materials of the self-assembled film.

In the self-assembled film, molecules 5 arrange themselves in orderly fashion on the surface of film-coated base material 6 as shown in FIG. 3 as the result of an automatic and spontaneous reaction between the functional groups (O portions) and the surface of film-coated base material 6. Accordingly, when a self-assembled film has been formed, the regular arrangement of atoms can be detected by surface analysis such as IR-RAS showing the peak at which bond IR activity is reflected.

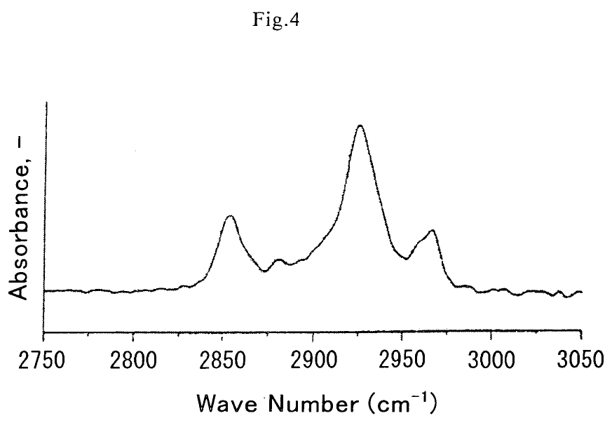

In other words, peaks resulting from the regular arrangement of molecules are observed in IR-RAS analysis (such as shown in FIG. 4) when a self-assembled film has been formed. However, peaks are not observed in non-self-assembled films in which the molecules are not regularly arranged.

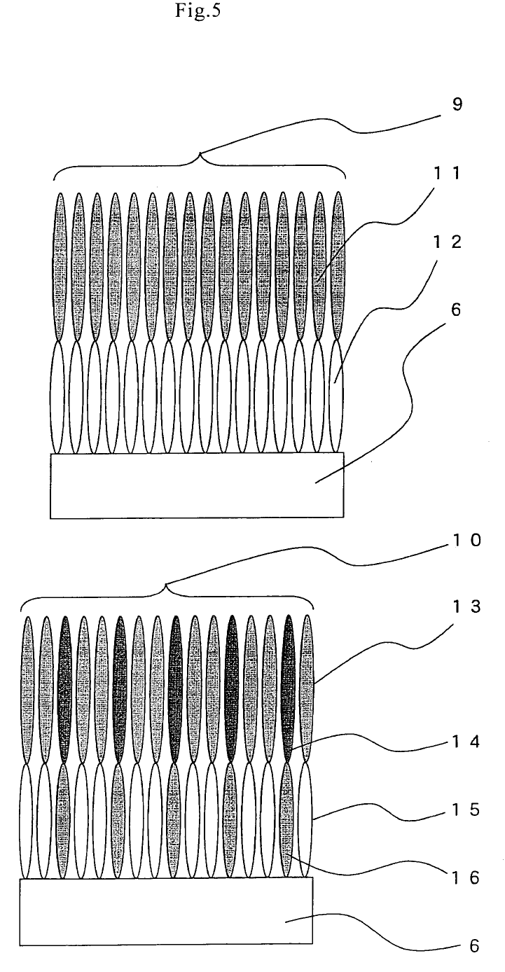

Self-assembled films are referred to as self-assembled monolayers (SAMs) in English. They sometimes denote a single molecular layer formed on the surface by a single film formation process, but may also denote a multimolecular layer formed by repeated film formation. The self-assembled film of the present invention comprises not just single molecular layers, but may comprise multimolecular layers 9 or 10 such as shown in FIG. 5.

The thickness of the self-assembled film formed on the surface of the glass material in the present invention is desirably greater than or equal to 0.1 nm and less than or equal to 30 nm. When the thickness of the self-assembled film is less than 0.1 nm or greater than 30 nm, the preventive effect on clouding, fogging, and/or cracking of the pressed lens surface tends to diminish. The thickness of the self-assembled film is preferably greater than or equal to 0.5 nm and less than or equal to 20 nm. The thickness of the self-assembled film can be measured by ESCA or with an ellipsometer.

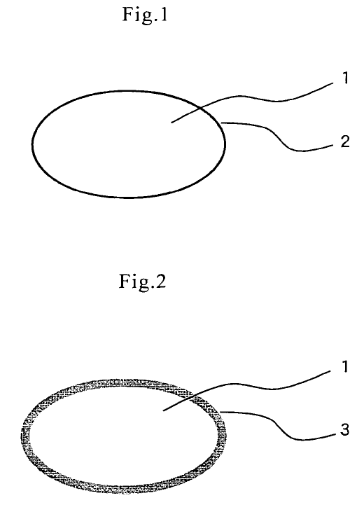

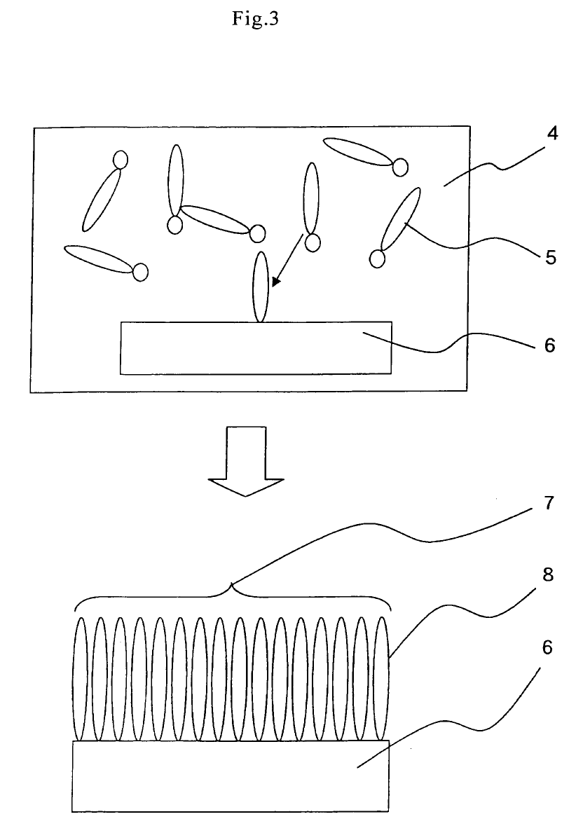

FIGS. 1 and 2 are sectional views of a model of the configuration of the glass material of the present invention. The glass material for molding employed in the method of Mode 1 of the present invention, as shown in FIG. 1, is a preformed glass material 1 the surface 2 of which has a surface free energy of greater than or equal to 60 mJ/m². The glass material for molding employed in the method of Mode 2 of the present invention, as shown in FIG. 2, is a preformed glass material 1 with a surface free energy of greater than or equal to 60 mJ/m² on the surface of which has been formed a layer 3.

In the method of manufacturing glass articles of the present invention, the above-described preformed glass material is first heat softened and then press molded with a pressing mold. Press molding of the glass material can be conducted by known methods. For example, a glass material is introduced into a precision-shaped pressing mold and softened by heating to a temperature corresponding to a viscosity in the glass of 10⁸ to 10¹² poises, after which the molding surface of the mold is transferred to the glass material. Alternatively, a glass material that has already been heated to a temperature corresponding to a viscosity of 10⁸ to 10¹² poises is introduced into a precision-shaped pressing mold and pressed to transfer the molding surface of the mold to the glass material. The atmosphere during molding is desirably non-oxidizing. The mold and glass material are then cooled and, preferably at a temperature less than or equal to the Tg, the glass article is removed from the mold, yielding a molded optical element.

The base material of the pressing mold can be selected from among the group of materials consisting of SiC, WC, TiC, TaC, BN, TiN, AlN, Si₃N₄, SiO₂, Al₂O₃,ZrO₂, W, Ta, Mo, cermet, syalon, mullite, carbon composite (C/C), carbon fiber (CF), and WC—Co alloy.

Further, a pressing mold having a mold separation film on the surface of the base material can be employed. The mold separation film formed on the base material surface may be a carbon-based coating selected from among the group consisting of diamond-like carbon films (DLC hereinafter), hydrogenated diamond-like carbon films (DLC:H hereinafter), tetrahedral amorphous carbon films (ta-C hereinafter), hydrogenated tetrahedral amorphous carbon films (ta-C:H hereinafter), amorphous carbon films (a-C hereinafter), hydrogenated amorphous carbon films (a-C:H hereinafter); a nitrogenated coating such as Si₃N₄, TIAlN, TiCrN, CrN, Cr,Ny, AlN, and TiN, or composite multilayer film or laminate film of the same (such as AlN/CrN, TiN/CrN); or a noble-metal alloy coating comprising platinum as its primary component, such as Pt—Au, Pt—Ir—Au, or Pt—Rh—Au.

The mold separation film may be formed by a method such as DC-plasma CVD, RF-plasma CVD, microwave plasma CVD, ECR-plasma CVD, optical CVD, laser CVD, and other plasma CVD methods; ion plating and other ionization vapor deposition methods; sputtering; vapor deposition; and the filtered cathodic arc (FCA) method.

The glass article manufactured by the method of the present invention may be an optical element such as a lens, mirror, grating, prism, microlens, or stacked diffraction optical element, as well as a molded glass article other than an optical element.

As set forth above, in the manufacturing of optical elements by the press molding of glass materials with a pressing mold, the present invention permits the production of stable glass articles using preformed glass material employed in moldings with a surface free energy of greater than or equal to 60 mJ/m² or glass materials obtained by forming a surface layer on a glass material employed in molding having a surface free energy of greater than or equal to 60 mJ/m² without producing clouding, fogging, and/or cracking.

### EXAMPLES

The present invention is described in detail below through examples.

### Example 1

A commercial optical precision cleansing unit was used to high-precision cleanse optical element molding materials by a wet cleansing method. Following cleansing, the molding materials were stored in a highly clean environment in nitrogen gas. Each lot that was cleaned and stored in this manner was subjected to a sampling investigation and the surface free energy was evaluated by the Owens-Wendt-Kaelble method based on wetting angle measurement with pure water and CH₂I₂. When the minimum surface free energy level of any of the lots was greater than or equal to 68 mJ/m², that lot satisfied the requirement of a surface energy of greater than or equal to 60 mJ/m² stated in the claims of the present invention.

The high-precision cleansing by the wet cleansing method was conducted as follows.

(1) One minute in a commercial water vat (ultrasound)→(2) one minute in a commercial water vat (ultrasound)→(3) one minute in a clean vat (ultrasound)→(4) one minute in a pure water vat (ultrasound)→(5) one minute in a pure water vat (ultrasound)→(6) one minute in an isopropyl alcohol vat (ultrasound)→(7) one minute in an isopropyl alcohol vat (ultrasound)→(8) a vapor drying vat. (1) to (7) were conducted at 30° C.

The storage in a highly clean environment in nitrogen gas was conducted under the following conditions. The optical element molding materials were placed in a vacuum desiccator, a vacuum was drawn to less than or equal to 10⁻² Torr, nitrogen gas backfilling was conducted three successive times to atmospheric pressure with nitrogen gas, and the molding materials were stored for two hours under a nitrogen atmosphere. The total organic carbon concentration in the vacuum desiccator was 100 micrograms C/L and the cleanliness class was ISO class 4.

The surface free energy was evaluated by the Owens-Wendt-Kaelble method based on wetting angle measurement with pure water and CH2I₂.

The glass material borate glass A of the optical element molding material of the present example was optical glass with a glass transition temperature of 520° C., a refractive index of 1.69350, and a linear expansion coefficient of 69×10⁻⁷/° C.

The optical element molding material was placed in a molding device. During placement, the environment of the molding material being displaced had a cleanliness class of ISO class 6, which is a total organic carbon concentration of less than or equal to 1000 micrograms C/L. Within the molding device, the cleanliness class was ISO class 5, with a total organic carbon concentration of less than or equal to 500 micrograms C/L. Next, in a nitrogen gas environment, the molding material was heated to 610° C. and pressed for one minute at a pressure of 150 kg/cm². Following pressure release, cooling was conducted at a rate of −50° C./min. until reaching 480° C., after which cooling was conducted at a rate greater than or equal to −200° C./min. Once the temperature of the press molded product had reached or dropped below 200° C., the molded product was removed. The pressing mold employed had a polycrystalline SiC molding surface manufactured by CVD that was mirror polished to Rmax=18 nm, after which an ion plating film forming device was used to form a DLC:H film as a mold separation film on the molding surface.

Convex meniscus lenses with a diameter of 12 mm were continuously pressed with the same mold. Observation of the optical elements through 2,000 pressing cycles revealed a good external appearance.

### Comparative Example 1

With the exception that following wet cleansing, storage was conducted for two days in a room with a total organic carbon concentration of greater than or equal to 12,000 micrograms C/L in air that was not cleaned, continuous pressing was conducted with a single press in the same manner as in Example 1. As in Example 1, each wet cleansed and stored lot was subjected to sampling investigation and the surface free energy thereof was evaluated by the Owens-Wendt-Kaelble method based on the measurement of the wetting angles of pure water and CH₂I₂. The minimum level of surface free energy was 42 mJ/m². The ratio of lots having a minimum surface free energy value of less than 60 mJ/m² was 28 percent.

When continuous pressing of these optical element molding materials was begun without separation, fused matter thought to be glass of sub-micrometer size was observed on the surface of the DLC:H mold separation film of the pressing mold at 650 pressing cycles. Further, when pressing was continued with the pressing mold, cracks continuously appeared in the molded optical elements, eventually precluding continued pressing. The cracks in the optical elements started at points of fusion on the DLC:H mold separation film surface of the pressing mold, requiring regeneration of the mold separating film on the surface of the pressing mold.

### Example 2

With the exception that after wet cleansing, storage was conducted for two days in a room with a total organic carbon concentration of greater than or equal to 8,000 micrograms C/L in air that was not cleaned, individual cleansed and stored lots of optical element molding materials prepared in the same manner as in Example 1 were subjected to sampling investigation in the same manner as in Example 1 and the surface free energy was evaluated by the Owens-Wendt-Kaelble method based on the measurement of the wetting angles of pure water and CH₂I₂. The minimum level of surface free energy was 45 mJ/m². The ratio of lots having a minimum surface free energy level of less than 60 mJ/m² was 19 percent. Lots having a minimum surface free energy level of less than 60 mJ/m² were removed and only the optical element molding materials of lots having a minimum surface free energy level of greater than or equal to 60 mJ/m² were continuously pressed in the same manner as in Example 1.

Observation of the optical elements through 2,000 pressing cycles with the same mold revealed a good external appearance.

### Example 3

An a-C:H coating 1 nm in thickness was formed by acetylene gas thermal decomposition CVD on just optical element molding materials from lots having a minimum surface free energy level of greater than or equal to 60 mJ/m² in the same manner as in Example 2.

The molding materials were stored for two days in a room identical to that in Example 2. The environment of the molding materials during transport had a cleanliness class of ISO class 6, with a total organic carbon concentration of 500 micrograms C/L. The total organic carbon concentration in the CVD device described below was 2,000 micrograms C/L, and the cleanliness class was ISO class 5.

The CVD based on acetylene gas thermal decomposition was conducted as follows.

A glass material was placed on a tray made of quartz which was then placed in a bell jar (reaction vessel). The interior of the bell jar was evacuated to less than or equal to 0:5 torr with a vacuum pump, heated, and maintained at 480° C. Gas was exhausted by vacuum pump while introducing nitrogen gas into the bell jar to maintain 160 torr and a 30 minute purge was conducted. Subsequently, the introduction of nitrogen gas was stopped. The interior of the bell jar was then reevacuated to less than or equal to 0.5 torr with a vacuum pump, 40 torr of acetylene gas was introduced for 20 min, and the introduction of gas was stopped. After cooling, atmospheric pressure was restored while diluting with nitrogen gas and the glass material was removed.

Continuous pressing was then conducted with a single mold. Observation of the optical elements through 2,000 pressing cycles with the same mold revealed a good or extremely good external appearance, as indicated in Table 3.

### Comparative Example 2

With the exception that after wet cleansing, storage was conducted for one week in a room with a total organic carbon concentration of greater than or equal to 20,000 micrograms C/L in air that was not cleaned, each wet cleansed and stored lot of optical element molding materials prepared in the same manner as Example 1 was subjected to sampling investigation and the surface free energy was evaluated by the Owens-Wendt-Kaelble method based on the measurement of the wetting angles of pure water and CH₂I₂. The minimum value of surface free energy was 38 mJ/m². The ratio of lots having a minimum surface free energy value of less than 60 mJ/m² was 42 percent. Without separation of these optical element molding materials, an a-C:H film 1 nm in thickness was formed by CVD in the same manner as in Example 3 and continuous pressing was begun. At 1,200 pressing cycles, fused matter thought to be glass of sub-micrometer size was observed on the DLC:H mold separation film surface of the pressing mold. Further, when pressing was continued with the pressing mold, cracks continuously appeared in the molded optical elements, eventually precluding the continuation of pressing. The cracks in the optical elements started at points of fusion on the DLC:H mold separation film surface of the pressing mold, requiring regeneration of the mold separating film on the surface of the pressing mold.

### Examples 4 to 11

In the same manner as in Example 2, the surface films shown in Tables 5 and 6 were formed only on optical element molding materials of lots having a minimum surface free energy level of greater than or equal to 60 mJ/m² and continuous pressing was conducted with a single mold. Observation of the optical elements through 2,000 pressing cycles with the same mold revealed a good or extremely good external appearance, as indicated in Table 5, 6.

TABLE 4
Examples and Comparative Examples

| Item | Example 1 | Comp. Example 1 | Example 2 | Example 3 | Comp. Example 2 |
|---|---|---|---|---|---|
| Glass material (Tg/Ts) | Borate glass A | Borate glass A | Borate glass A | Borate glass A | Borate glass A |
| | (520/560) | (520/560) | (520/560) | (520/560) | (520/560) |
| Cleansing method/storage | Wet method/stored | Wet method/stored | Wet method/stored | Wet method/stored | Wet method/stored |
| (storage environment: total | in nitrogen gas | indoors 12,000 | indoors 8,000 | indoors 8,000 | indoors 20,000 |
| organic carbon concentration, | (100 micrograms | micrograms C/L, no | micrograms C/L, no | micrograms C/L, no | micrograms C/L, no |
| degree of cleanliness) | C/L, ISO class 4) | cleaning | cleaning | cleaning | cleaning |
| Minimum surface free energy | 68 mJ/m² | 42 mJ/m² | 45 mJ/m² | 42 mJ/m² | 38 mJ/m² |
| level by lot | | | | | |
| Ratio of lots having a | 0% | 28% | 19% | 21% | 42% |
| minimum surface free energy | | | | | |
| level of less than 60 mJ/m² | | | | | |
| Lot selection | No | No | Yes | Yes | No |
| Surface layer | No | No | No | a-C:H | a-C:H |
| Method of film formation | — | — | — | CVD method | CVD method |
| Surface layer thickness | — | — | — | 1 nm | 1 nm |
| Shape of optical element | Convex meniscus | Convex meniscus | Convex meniscus | Convex meniscus | Convex meniscus |
| | lens 12 mm in dia. | lens 12 mm in dia. | lens 12 mm in dia. | lens 12 mm in dia. | lens 12 mm in dia. |
| External appearance of | ⊚ | X | ο | ⊚ | X |
| optical element* | | | | | |

TABLE 5
Examples and Comparative Examples

| Item | Example 4 | Example 5 | Example 6 | Example 7 |
|---|---|---|---|---|
| Glass material (Tg/Ts) | Borate glass A | Borosilicate glass B | Borosilicate glass B | Borosilicate glass B |
| | (520/560) | (500/540) | (500/540) | (500/540) |
| Cleansing method/storage | Wet method → | Wet method/stored in | Wet method/stored in | Wet method → UV |
| (storage environment: total | UV ozone | clean room 300 | clean room 300 | ozone cleaning/stored |
| organic carbon concentration, | cleaning/stored in | micrograms C/L, ISO | micrograms C/L, ISO | in clean room 100 |
| degree of cleanliness) | clean room 100 | class 4 | class 4 | micrograms C/L, ISO |
| | micrograms C/L, | | | class 4 |
| | ISO class 4 | | | |
| Minimum surface free energy | 73 mJ/m² | 63 mJ/m² | 62 mJ/m² | 81 mJ/m² |
| level by lot | | | | |
| Lot selection | No | No | No | No |
| Surface layer | No | No | a-C:H | Self-assembled film |
| Method of film formation | — | — | CVD method | Immersion for 60 sec at |
| | | | | 20° C. in hexane solution |
| | | | | of 1 wt % |
| | | | | chlorotrimethyl silane |
| | | | | (self-assembly |
| | | | | confirmed by IR-RAS |
| | | | | peak) |
| Surface layer thickness | — | — | 3 nm | 4 nm |
| Shape of optical element | Convex meniscus | Biconvex meniscus lens | Biconvex meniscus lens | Concave meniscus lens |
| | lens 9 mm in dia. | 15 mm in dia. | 18 mm in dia. | 7 mm in dia. |
| External appearance of | ⊚ | ◯ | ◯ | ⊚ |
| optical element* | | | | |

TABLE 6
Examples and Comparative Examples

| Item | Example 8 | Example 9 | Example 10 | Example 11 |
|---|---|---|---|---|
| Glass material (Tg/Ts) | Borate glass C | Fluorophosphate glass | Borate glass E | Fluorophosphate glass |
| | (500/535) | D (365/403) | (560/600) | D (365/403) |
| Cleansing method/storage | UV ozone | Wet method/stored | Wet method/stored in | Wet method → UV |
| (storage environment: total | cleaning/indoor | indoors 9,000 | clean room 100 | ozone cleaning/stored |
| organic carbon concentration, | storage 11,000 | micrograms C/L, no | micrograms C/L, ISO | in nitrogen gas 100 |
| degree of cleanliness) | micrograms C/L, | cleaning | class 4 | micrograms C/L, ISO |
| | no cleaning | | | class 6 |
| Minimum surface free energy | 58 mJ/m² | 45 mJ/m² | 71 mJ/m² | 62 mJ/m² |
| level by lot | | | | |
| Lot selection | Yes | Yes | No | No |
| Surface layer | No | C | ta-C | No |
| Method of film formation | — | Vapor deposition | FCA method | — |
| Surface layer thickness | — | 2 nm | 3 nm | — |
| Shape of optical element | Biconvex meniscus | Biconvex meniscus lens | Biconvex meniscus lens | Concave meniscus lens |
| | lens 14 mm in dia. | 6 mm in dia. | 6 mm in dia. | 5 mm in dia. |
| External appearance of | ◯ | ⊚ | ⊚ | ⊚ |
| optical element* | | | | |

*External appearance of optical element: The external appearance of the optical element through 2,000 pressing cycles in a single mold.
⊚: No cracking, clouding, or fogging exhibited at 2,000 pressing cycles.
◯: Fewer than 50 lenses exhibiting cracking, clouding, or fogging at 2,000 pressing cycles.
X: Cracking occurring prior to 1,000 pressing cycles.

What we claimed is

1. A method of manufacturing a glass article comprising the steps of heat softening a glass material that has been preformed and press molding the glass material with a pressing mold, characterized in that a glass material having a surface free energy of greater than or equal to 60 mJ/m² is fed to the heat softening step, and then fed to the press molding step.

2. The method of manufacturing according to claim 1, wherein the preformed glass material is washed to achieve a surface free energy of greater than or equal to 60 mJ/m², and kept in an atmosphere capable of maintaining a surface free energy of greater than or equal to 60 mJ/m² until the start of the heat softening step.

3. A method of manufacturing a glass article comprising the steps of heat softening a glass material that has been preformed and press molding the preformed glass material with a pressing mold, characterized in that a surface layer is formed on a preformed glass material having a surface free energy of greater than or equal to 60 mJ/m², and then the preformed glass material is fed to the heat softening step and press molding step.

4. The method of manufacturing according to claim 3, wherein the surface layer is a thin film comprised primarily of carbon with a film thickness of greater than or equal to 0.1 nanometer and less than or equal to 1 micrometer.

5. The method of manufacturing according to claim 3 or 4, wherein the preformed glass material is washed to achieve a surface free energy of greater than or equal to 60 mJ/m², and kept in an atmosphere capable of maintaining a surface free energy of greater than or equal to 60 mJ/m² until the surface layer is formed.
